(19) United States
(12) Patent Application Publication
(10) Pub. No.: US 2024/0383128 A1
(43) Pub. Date: Nov. 21, 2024

(54) INDUSTRIAL ROBOT WITH CABLE WIRING STRUCTURE

(71) Applicant: Fanuc Corporation, Yamanashi (JP)

(72) Inventors: Kyou Sugihara, Minamitsuru-gun, Yamanashi (JP); Genki Miyazaki, Minamitsuru-gun, Yamanashi (JP)

(73) Assignee: Fanuc Corporation, Yamanashi (JP)

(21) Appl. No.: 18/693,244

(22) PCT Filed: Sep. 30, 2021
(86) PCT No.: PCT/JP2021/036210

§ 371 Date: Mar. 19, 2024

(51) Int. Cl. B25J 9/00; B25J 18/00

(52) U.S. Cl. CPC B25J 9/0009; B25J 18/00

(57) ABSTRACT

Provided is an industrial robot with a cable wiring structure that improves the degree of freedom in disposing objects to be connected with a cable. The industrial robot has: a first arm; a second arm pivotally attached to the first arm; and at least one cable arranged between the first arm and the second arm. The robot further has a groove formed on a side surface of the second arm. The groove is configured to store the cable. The groove has: a first wide part formed to expand in a width direction with respect to a longitudinal direction of the second arm, and to allow the cable to be pulled out; and a second wide part formed to expand in a direction different from the first wide part, and to allow the cable to be pulled out.

### CROSS REFERENCE TO RELATED APPLICATIONS

This is the U.S. National Phase application of PCT/JP2021/036210, filed Sep. 30, 2021, the disclosures of this application being incorporated herein by reference in their entireties for all purposes.

### FIELD OF THE INVENTION

The present invention relates to an industrial robot having a cable wiring structure.

### BACKGROUND OF THE INVENTION

In an industrial robot such as a vertical articulated robot having a plurality of arms, a cable such as a motor cable for driving each arm is arranged along an outer surface of the arm. In order to prevent the cable from interfering with the arm and/or being damaged when each arm of such a robot is operated, there is a well-known technique of forming a groove or recess on the arm and position the cable in the groove or the recess (e.g., see Patent Literature 1 to 4).

### PATENT LITERATURE

[PTL 1] JP 1995 (H07)-100787 A
[PTL 2] JP 2018-122336 A
[PTL 3] JP 2018-015872 A
[PTL 4] JP 2018-192607 A

### SUMMARY OF THE INVENTION

When arranging a cable between a first arm (e.g., an upper arm) of the robot and a second arm (e.g., a forearm) rotatably attached to the first arm, the cable may be attached as far in front of the second arm as possible using a clamp, etc., in order to avoid interference between the cable and the other components. In this case, however, there are potential problems such as impairment of the appearance of the robot and an increase in the length of the cable exposed, and thus one way to minimize such problems is to form a groove in the second arm and accommodate the cable in the groove.

However, in the case of an industrial robot, a plurality of cables must be connected to different objects in many instances. For example, a plurality of motors and a branch board may be provided at a base of the second arm. When the cable is contained in the groove in such a robot, depending on the location of the object to be connected to the cable, the cable may be pulled out of the groove and bent greatly and routed toward the object, resulting in an excessive load being applied to the cable.

One aspect of the present disclosure is an industrial robot comprising: a first arm; a second arm pivotally attached to the first arm; at least one cable arranged between the first arm and the second arm; and a groove formed on a side surface of the second arm and configured to accommodate the cable, wherein the groove comprises: a first wide part expanding in a width direction with respect to a longitudinal direction of the cable; and a second wide part expanding in a direction different from the first wide part.

According to the present disclosure, since the groove formed on the second arm includes the wide parts, it is then possible to selectively pull out the cable in the groove in any of a plurality of directions. Therefore, even when there are a plurality of objects to which the cable is to be connected, it is possible to smoothly route the cable to any of the objects without the risk of an excessive load being applied to the cable.

### BRIEF DESCRIPTION OF DRAWINGS

FIG. 1 is a schematic configuration view of a robot according to a preferred embodiment.

FIG. 2 is a cross-sectional view along a II-II line in FIG. 1.

FIG. 3 is a view showing an example of a cable routing in the robot of FIG. 1.

FIG. 4 is an enlarged view of a groove formed on a second arm.

FIG. 5 is a view of the groove in FIG. 4 viewed from a different angle.

FIG. 6 is a view showing an example in which a cover is provided to the robot of FIG. 1.

FIG. 7 is a view of the robot of FIG. 6 viewed from above.

FIG. 8 is a view showing a structural example of the cover.

FIG. 9 is a partial enlarged view showing an area around the cover of the robot of FIG. 6.

FIG. 10 is a view of the robot of FIG. 6 viewed from a different angle.

FIG. 11 is a view showing a structural example of a parallel link robot on which a groove can be formed.

FIG. 12 is a view showing another structural example of a parallel link robot on which a groove can be formed.

### DETAILED DESCRIPTION OF EMBODIMENTS OF THE INVENTION

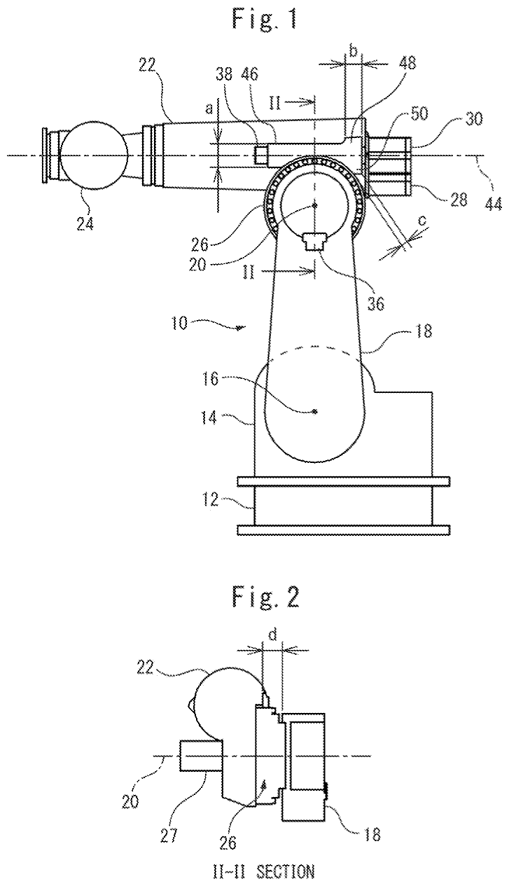

FIG. 1 a schematic configuration view of an industrial robot 10 according to a preferred embodiment, and FIG. 2 is a cross-sectional view along a II-II line in FIG. 1. Herein, the robot 10 is a vertical articulated robot having a serial link structure, and has a base 12 installed at a predetermined place such as a production line in a factory, a rotating body 14 pivotally attached to the base 12, a first arm (upper arm) 18 pivotally attached to the rotating body 14 about a first axis 16, a second arm (forearm) 22 pivotally attached to the first arm 18 about a second axis 20, and a wrist part 24 pivotally attached to the second arm 22. In FIGS. 1 and 2, a cable described below is not illustrated, this being for the purpose of clarity.

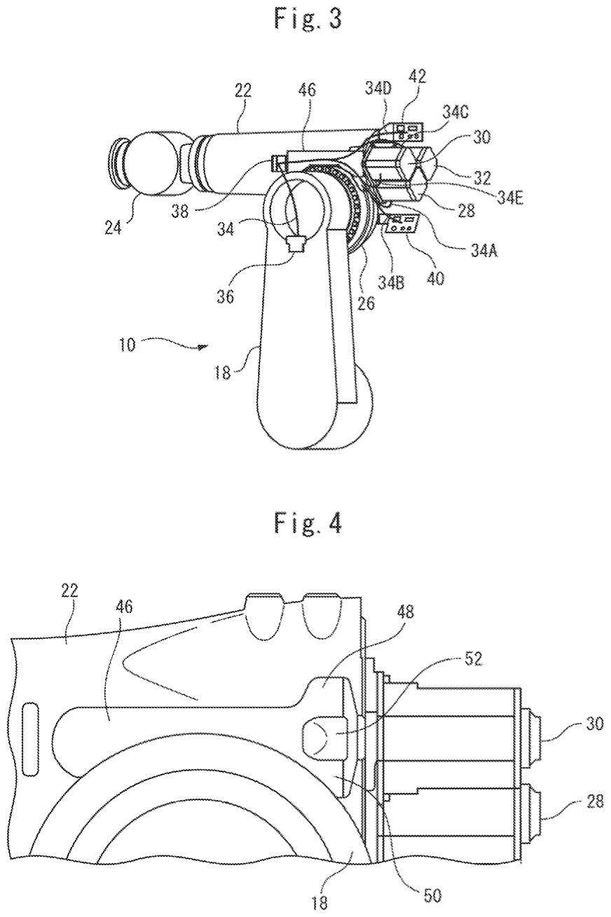

FIG. 3 is a view of the robot 10 viewed diagonally from behind. A speed reducer 26 is located between the first arm 18 and the second arm 22, and the speed reducer 26 is configured to decelerate the rotation of a motor 27 (see FIG. 2) provided on (the base of) the second arm 22, and amplify the torque of the motor 27, so as to rotate the second arm 22 relative to the first arm 18. Further, motors 28, 30 and 32 for rotationally driving the wrist part 24, etc., are provided at the base of the second arm 22 (or the side end of the first arm 18), and power is supplied to the motors 28, 30 and 32 by means of at least one cable 34. In this embodiment, it is assumed that the cable 34 is a cable bundle including a plurality of cables, which are connected to different motors or different branch boards.

The cable bundle 34 passes from a power source (not shown) through the base 12 and the rotating body 14, and is fixed by a first fixture 36 such as a clamper provided on the first arm 18, and then fixed by a second fixture 38 such as a clamper provided on the second arm 22. After that, the cable bundle 34 is connected to the above-mentioned motors 28, 30 and 32, or branch boards 40 and 42 provided on the base of the second arm 22, etc. In the example of FIG. 3, the cable bundle 34 includes five cables 34A to 34E. the cables 34A, 34C and 34E are respectively connected to the motors 28, 32 and 30, located at the base of the second arm 22. The cables 34B and 34D are respectively connected to the branch boards 40 and 42, located at the base of the second arm.

The branch boards 40 and 42 can be connected to cables (not shown) for supplying power etc. to an end effector (not shown) such as a hand or a welding torch provided on the wrist part 24. In this embodiment, these branch boards are arranged at positions opposite to each other (180 degrees) with respect to a longitudinal central axis 44 of the second arm 22 (see FIG. 1). However, it should be noted that this arrangement of the branch boards is merely an example, and there are no particular restrictions on the number and/or the positions of the branch boards.

In this embodiment, the cable bundle 34 clamped by the second fixture 38 is accommodated in a groove (recess) 46 formed on the side surface of the second arm 22, extends to or near the base of the second arm 22, and is connected to an electrical component such as the motor or the branch board. Also in conventional robots, a groove or the like for accommodating the cable may be formed on the side surface of the second arm, but such a groove has a simple straight structure with a constant width. Therefore, depending on the location of an object to which the cable is connected, it may be difficult to connect the cable pulled out from the groove to the object, or the cable may be bent such that it has a relatively small curvature, resulting in excessive load being applied to the cable.

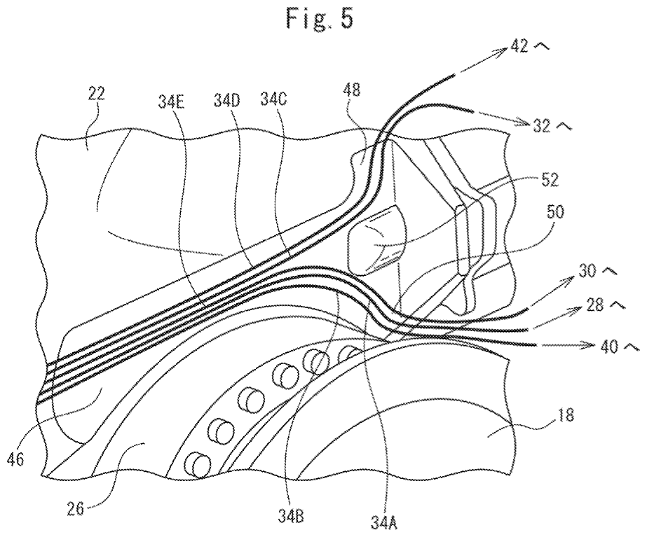

In view of the above, in this embodiment, as shown in FIGS. 4 and 5, which are partially enlarged views, the groove 46 extends along the longitudinal direction of the second arm 22, and has a first wide part 48 expanding in the width direction of the groove 46 (or the direction substantially perpendicular to the longitudinal direction of the second arm 22) at the base of the second arm 22, and a second wide part 50 expanding in a direction different from the expanding direction of the first wide part 48 at the base of the second arm 22. It should be noted that in FIG. 4, the cable is not illustrated for the purpose of clarity.

The groove 46 has the plurality of wide parts at the end on the base side of the second arm 22, which are wider than the parts other than the end on the base side. By virtue of this, a range in which each of the cable 34A to 34E can be smoothly pulled out from the groove 46 is greatly expanded. In other words, the width-wide structure of the groove 46 makes it possible to select which direction (such as the direction toward the motor 28 or the direction toward the branch board 42) out of a plurality of directions each of the cables 34A to 34E should be pulled out. Therefore, each cable can be pulled out toward the object to which the cable is to be connected, without being bent such that it has a small curvature or being subjected to excessive loads.

In this embodiment, by accommodating the cable bundle 34 in the groove 46 formed on the side surface of the second arm 22, several effects can be obtained, e.g., interference between the cable bundle 34 and the other components is prevented, and the cable bundle 34 is less visible to the outside, improving the appearance of the robot, etc. Further, each cable can be pulled out in an appropriate direction, depending on the location of the object to which the cable is connected, such as the branch board and (a connector of) the motor. For example, the cable having a basic configuration including the motor cable may be pulled out from the second wide part 50, and when another cable is added as an option, the optional cable may be pulled out from the first wide part 48. As such, even when there are a large number of cables, the cables can be appropriately routed. Further, since there are multiple directions in which the cables can be pulled out smoothly, the degree of freedom in arranging the branch board increases, leading to an increase in the degree of freedom in robot design.

Optionally, the groove 46 may have a raised part 52 between the first wide part 48 and the second wide part 50, the raised part 52 having a depth smaller than a depth of either the first wide part 48 or the second wide part 50. In this way, the groove 46 has a bifurcated shape which branches at the base of the second arm 22, and each cable can be more smoothly connected to a predetermined component such as the branch board. In other words, the raised part 52 functions as a guide part configured to guide each cable to the first wide part 48 or the second wide part 50. Further, by providing the raised part 52 to the groove 46, an internal space of the second arm 22 can be expanded, and thus the number and size of components which can be positioned inside the second arm 22 can be increased.

The dimensions of each part of the groove 46 shown in FIGS. 1 and 2 can be determined as appropriate based on the configuration of the cable bundle, and/or the position of the object to which each cable is connected, etc. For example, a width “a” of the groove 46 can be determined based on the thickness and number of cables included in the cable bundle 34, and a dimension “b” of the first wide part 48 and a dimension “c” of the second wide part 50 can be determined based on the thickness and number of cables passing through the first or the second wide part, as well as the location of the object such as the motor or branch board. Further, a dimension “d”, which is the distance between the side surface of the second arm 22 and the end surface of the first arm 18, can be determined so that the cable bundle 34 does not interfere with the first arm 18 even when the robot is operated.

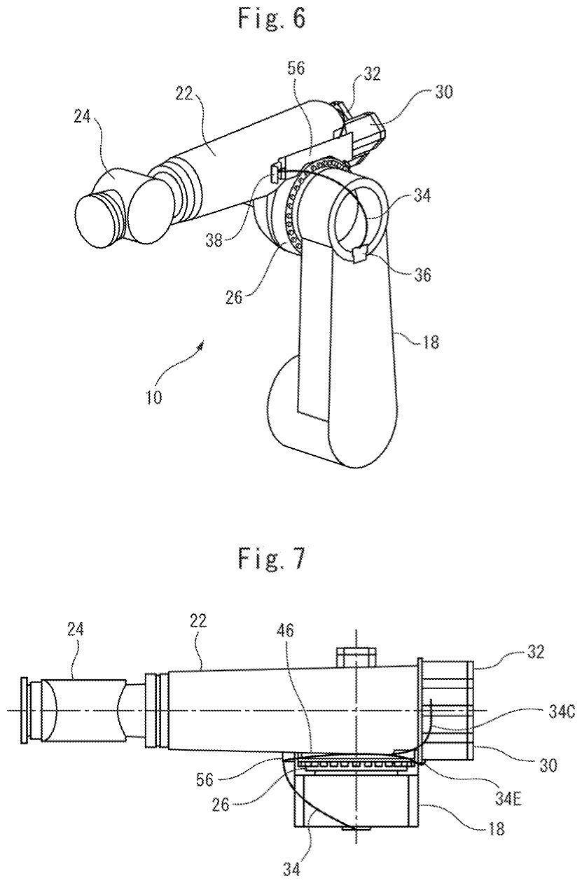

FIG. 6 shows an example in which an attachment 56 is provided on the side surface of the second arm 22 of the robot 10 to cover the cable in the groove 46, and FIG. 7 is a view of the robot 10 of FIG. 6 viewed from above.

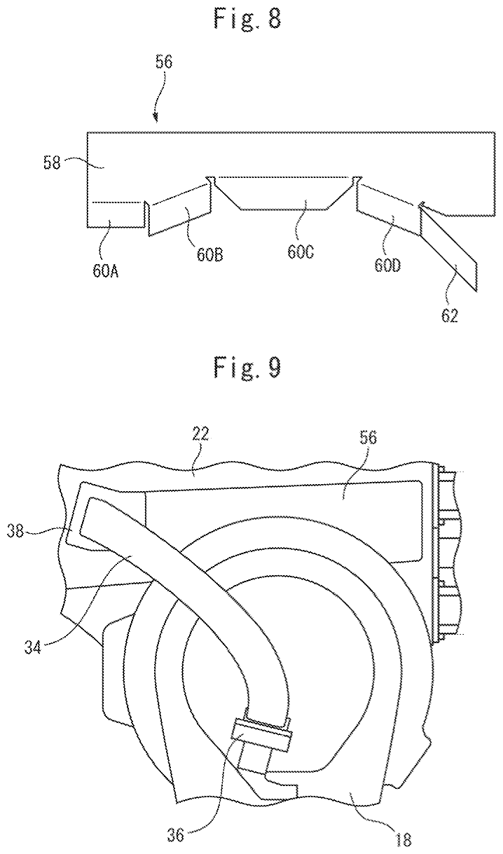

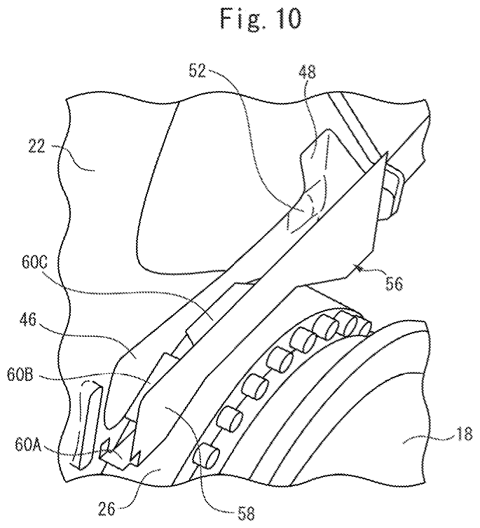

As shown in FIG. 8, the attachment 56 preferably has approximately the same size and shape as the groove 46, and includes a flat cover part 58 configured to cover the cable bundle 34 within the groove 46 and at least one spacer part 60A to 60D, 62 which are connected to the cover part 58 at a predetermined angle (about 90 degrees in the illustrated example). In the illustrated example, the attachment 56 can be manufactured by cutting and bending a (preferably one) sheet metal. More specifically, reference numerals 60A to 60D are bent parts, and reference numeral 62 is a tab-shaped member connected to the bent part 60D. By providing such an attachment 56 in the groove 46 and passing the cable bundle 34 between the groove 46 and the attachment 56 as shown in FIG. 7, the appearance (design) of the robot can be further improved as shown in FIG. 9, and the cable bundle 34 within the groove 46 can be protected from splashing of cutting fluid, etc.

As shown in FIG. 10, the bent parts 60A to 60D and the tab 62 of the attachment 56 are arranged so as to be interposed between the cable bundle 34 (omitted for clarity in FIG. 10) in the groove 46 and the surface of the speed reducer 26, so that the cable bundle 34 is prevented from coming into contact with the surface of the speed reducer 26, which can become hot during operating of the robot, and the lifespan of the cables can be extended. Furthermore, the bent parts 60A to 60D and the tab 62 of the attachment 56 are configured to follow (but not contact) the outer circumferential surface of the approximately cylindrical speed reducer 26, and in the example of FIG. 8, the bent parts 60A to 60D and the tab 62 can be formed integrally with the cover part 58 by simple processing such as bending of the sheet metal.

However, the configuration of the cover part and the spacer part described above are not limited to those produced by cutting and bending a single sheet metal as shown in FIG. 8. For example, a material such as resin with low thermal conductivity may be used as the material for at least one of the cover part and the spacer part, and the cover part and the spacer part may be separated from each other or may be connected to each other. Further, the groove may be provided with only one of the cover part and the spacer part.

In the above embodiment, the upper arm 18 of the robot 10 is referred to as the first arm, and the forearm 22 of the robot 10 is referred to as the second arm, whereas the present disclosure is not limited as such. For example, a structure similar to the groove 46 described above may be formed on the side surface of the upper arm 18 which is rotatably attached to the rotating body 14, and the cable arranged between the rotating body 14 and the upper arm 18 may be accommodated in the structure. In this case, the rotating body 14 and the upper arm 18 correspond to the first arm and the second arm, respectively.

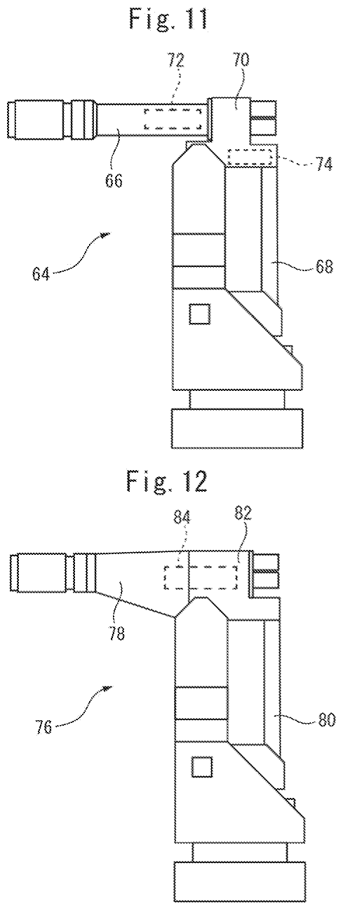

In the above embodiment, a robot with a serial link structure is described as a vertically articulated robot, whereas the object to which the present disclosure may be applied is not limited as such. For example, a parallel link robot 64 as shown in FIG. 11 includes an upper arm 66, a link 68 rotatably connected to the upper arm 66, and a housing 70 configured to accommodate a base of the upper arm 66 and an upper end of the link 68. The upper arm 66 and the housing 70 are separate members. In such a case, a structure similar to the groove 46 or the attachment 56 described above may be formed at an appropriate site 72 on the side surface of the upper arm 66.

Alternatively, a parallel link robot 76 exemplified in FIG. 12 includes an upper arm 78, a link 80 rotatably connected to the upper arm 78, and a housing 82 configured to accommodate a base of the upper arm 78 and an upper end of the link 80. The upper arm 78 and the housing 82 are integrally constructed as substantially one member. In such a case, a structure similar to the groove 46 or the attachment 56 described above may be formed at an appropriate site 84 on the side surface of the member constituting the upper arm 78 and the housing 82.

In addition, although not shown in the drawings, a structure similar to the groove 46 and the attachment 56 described above may be arranged on an arm of a horizontal articulated robot such as a SCARA robot. In this way, the present disclosure is applicable to various types of robots, and in those cases as well, substantially the same effects as those of the above embodiments can be obtained.

### REFERENCE SIGNS LIST

10 serial link robot
12 base
14 rotating body
18 first arm
22 second arm
24 wrist part
26 speed reducer
27, 28, 30, 32 motor
34 cable bundle
34A-34E cable
36 first fixture
38 second fixture
40, 42 branch board
48 first wide part
50 second wide part
52 raised part
56 attachment
58 cover part
60A-60D spacer part
62 tab
64, 76 parallel link robot

1. An industrial robot comprising:
a first arm;
a second arm pivotally attached to the first arm;
at least one cable arranged between the first arm and the second arm; and
a groove formed on a side surface of the second arm and configured to accommodate the cable,
wherein the groove comprises:
a first wide part expanding in a width direction with respect to a longitudinal direction of the cable; and
a second wide part expanding in a direction different from the first wide part.

2. The industrial robot according to claim 1, wherein the groove has a raised part between the first wide part and the second wide part, the raised part having a depth smaller than a depth of either the first wide part or the second wide part.

3. The industrial robot according to claim 1, wherein the industrial robot has a cover part configured to cover the cable in the groove.

4. The industrial robot according to claim 1, wherein the industrial robot has a spacer part positioned between the cable in the groove and a surface of a speed reducer arranged between the first and second wide parts.

5. The industrial robot according to claim 4, wherein the industrial robot has an attachment manufactured by cutting and bending a sheet material, the attachment including the cover part configured to cover the cable in the groove and the spacer part connected to the cover part.

6. The industrial robot according to claim 1, wherein the industrial robot has a vertical articulated structure.

7. The industrial robot according to claim 1, wherein a plurality of branch boards are provided to the second arm.
